(19) United States
(12) Patent Application Publication
(10) Pub. No.: US 2026/0365346 A1
(43) Pub. Date: Nov. 19, 2026

(54) Fiber-optic controlled drone carrier (with smaller attack drones on board) for effective operation in electronic warfare environments

(71) Applicant: Ruslan Prysiazhnyi, Orlando, FL (US)

(72) Inventor: Ruslan Prysiazhnyi, Orlando, FL (US)

(21) Appl. No.: 19/206,747

(22) Filed: May 13, 2025

(51) Int. Cl. B64U 80/82; B64U 10/60; B64U 70/20; B64U 80/30; B64U 101/18

(52) U.S. Cl. CPC B64U 80/82; B64U 10/60; B64U 70/20; B64U 80/30; B64U 2101/18; B64U 2201/20

(57) ABSTRACT

A fiber-optic controlled unmanned aerial vehicle (UAV) system for operation in electronic warfare environments is disclosed. The system comprises a carrier UAV having an internal or external storage compartment or open platform configured to carry a plurality of deployable attack drones. Each attack drone is connected to the carrier UAV by a respective optical fiber forming a fiber-optic tether system configured to transmit control signals and receive feedback signals. A deployment mechanism selectively releases the attack drones from the carrier UAV while maintaining fiber-optic communication. A control system transmits operational commands through the optical fibers to the deployed attack drones, enabling interference-resistant control in environments subject to radio frequency jamming. The system further includes a disconnection mechanism configured to selectively sever the optical fibers upon completion of a predetermined mission parameter, allowing continued operation or retrieval of the carrier UAV.

### 2. FIELD OF THE INVENTION

This invention relates to unmanned aerial vehicle (UAV) systems, in particular, a special drone carrier designed for deployment and fiber-optic control of attack drones (combat FPV drones) in electronic warfare conditions.

The invention ensures stable, interference-free communication using fiber-optic links, preventing electronic jamming and signal disruption while maintaining secure and precise operational control.

### 3. BACKGROUND OF THE INVENTION

Modern electronic warfare (EW) environments pose significant challenges to traditional drone communication and control systems. Conventional UAVs rely on radio frequency (RF) signals for navigation and coordination, which are susceptible to jamming, interception, and spoofing by hostile forces. These vulnerabilities limit the effectiveness of drone operations in contested airspace.

Existing swarm drone systems typically depend on wireless networks, making them unreliable in heavily jammed environments. Furthermore, maintaining secure coordination between a drone carrier and its deployed drones is difficult when communication is compromised.

To overcome these challenges, the present invention introduces a fiber-optic controlled drone carrier (“drone-queen”) that uses optical fiber connections for secure, interference-resistant control of attack drones. The fiber-optic tether ensures a stable, high-bandwidth connection between the drone carrier and the deployed attack drones, preventing external interference and enhancing precision in combat operations.

Thus, the drone carrier can deliver combat drones to the last mile—to the edge of the effective range of enemy electronic warfare devices—and send combat drones into enemy-protected areas using fiber-optic cable control. In this case, the operator will be able to control the attacking drone during the mission regardless of enemy radio interference—the operator will have a video image from the combat drone (FPV kamikaze drone) until the last second. Also, if the first attack is unsuccessful, the operator can send the next drone or drones to ensure the success of the mission.

After completing the task, the drone carrier returns home or performs another mission. At the same time, we emphasize that the carrier itself can use either fiber optic or radio communication to communicate with the operator, depending on the surrounding conditions and the needs of the mission.

### 4. SUMMARY OF THE INVENTION

The invention provides a fiber-optic controlled drone carrier (“drone-queen”), designed to:
Deploy and control multiple attack drones via fiber-optic tethers, ensuring secure, interference-free communication.
Operate effectively in electronic warfare environments, where RF-based control methods are unreliable due to jamming or interception.
Provide a high-bandwidth, low-latency connection between the operator, the drone-queen, and the attack drones, enabling precise mission execution.
Break the fiber-optic connection with attack drones after engagement, allowing the drone-queen to return to base safely.

The drone-queen serves as a central command platform, carrying multiple attack drones that can be launched and controlled through fiber-optic communication lines. The system ensures continuous and secure operator control, even in environments with heavy electronic countermeasures.

### 5. BRIEF DESCRIPTION OF THE DRAWINGS

The “drone-queen” is a large six-propeller or eight-propeller drone, similar to drones used in agriculture, which has a large carrying capacity—examples are shown in Appendix FIG. 4. Such a drone can have a platform for placing smaller combat or reconnaissance drones underneath—combat drones connected via fiber optic connection can take off from the platform.

Such a drone carrier (drone queen) can be connected to the operator via fiber optic or radio communication, depending on the environmental conditions and the task at hand. The main thing is to have fiber optic communication between the carrier and its passengers—smaller active drones—which ensures controlled mission execution in the last mile, where radio communication is unstable.

In practice, the use of this (proposed) principle also allows small FPV drones, which have a relatively low payload of 2-3 kg, to work with heavier loads, because when they take off from the carrier drone, they fly downwards without having to climb, and therefore they can carry significantly more kg of payload. We have confirmed this through practical tests.

Note: In some illustrations, for illustrative purposes, we depict a flying drone carrier in the form of an airplane.

FIG. 1—isometric view of the carrier UAV (“drone-queen”) (Page 10).

Shows the main airframe 10, open or closed compartment/platform 20 in the lower part of the carrier drone for storing and transporting smaller combat FPV drones, and fiber-optic deployment ports 30 beneath the fuselage.

FIG. 2—Side view during deployment (Page 11).

Illustrates the carrier UAV 10 in flight, four attack drones 40 descending on fiber-optic tethers 30, remote operator station 50, and one drone engaging target structure 60.

FIG. 3—Post-engagement sequence (Page 11).

Depicts attack drone 22 after munition release 28, severed tether marked “X” on fiber-optic line 34, and carrier UAV 10 preparing to depart the area.

FIG. 4—examples of drone carriers (“drone-queen”) and photos from testing (Page 12).

### 6. DETAILED DESCRIPTION OF THE INVENTION

### 6.1 Structure and Components

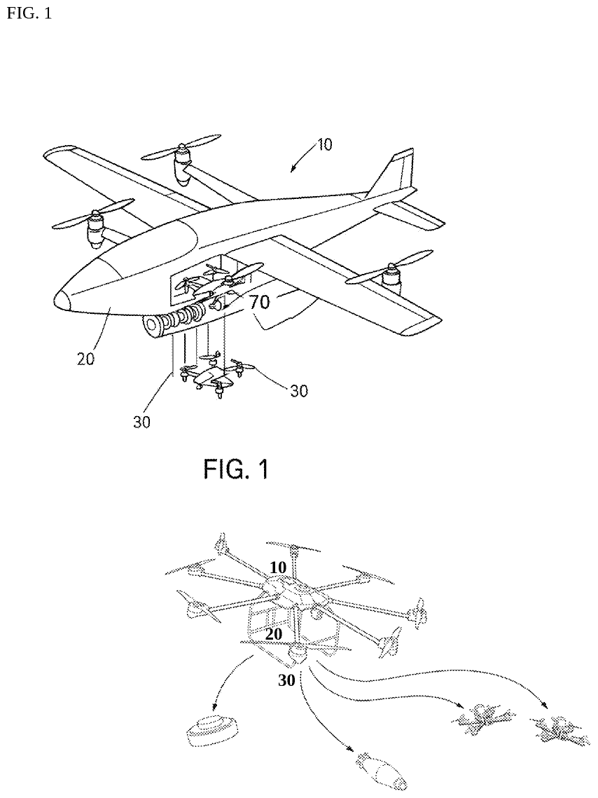

### 1. Drone-Queen Carrier UAV (FIG. 1)

The drone-queen is a large, high-endurance UAV, designed to transport and deploy multiple attack drones in combat environments.
Constructed from lightweight composite materials, ensuring maximum flight efficiency and maneuverability.
Equipped with multiple fiber-optic connection ports, enabling simultaneous operation of several attack drones.
Features an internal/external storage and launch bay or platform for placing smaller combat or reconnaissance drones underneath, allowing for secure transport and controlled deployment of attack drones (FPV drones).

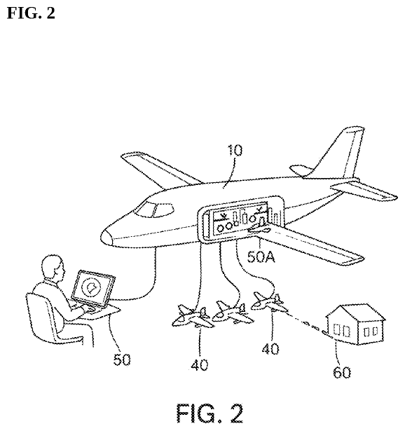

### 2. Fiber-Optic Control System (FIG. 2)

The drone-queen utilizes fiber-optic communication lines to establish direct, interference-free control over attack drones.
Each attack drone remains physically tethered via optical fiber, ensuring secure and uninterrupted communication with the operator.
High-speed data transmission allows for real-time video feed, target tracking, and precision control.
The fiber-optic system prevents electronic interference, hacking, or jamming, making the system resilient in hostile environments.

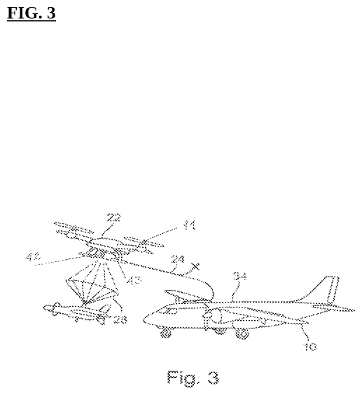

### 3. Attack Drones (FIG. 2, FIG. 3)

Each attack drone is lightweight, high-speed, and designed for precision targeting.
Equipped with guided munitions, ensuring effective engagement of designated targets.
Remains tethered to the drone-queen via fiber-optic connection until mission execution.
Can be deployed in swarms, allowing for coordinated attacks on multiple targets.

### 4. Fiber-Optic Disconnection Mechanism (FIG. 3)

Once an attack drone reaches its target and deploys its munition, the drone-queen automatically severs the fiber-optic connection.
The attack drone completes its mission independently, while the drone-queen returns to base with its remaining drones.
The fiber-optic disconnection ensures that no traceable communication links remain, preventing enemy countermeasures from tracking the drone-queen.

### 6.2 Principle of Operation

### 1. Mission Deployment

The operator identifies a target and directs the drone-queen to the operational zone.
The drone-queen launches one or more attack drones, maintaining fiber-optic control over their navigation and targeting.

### 2. Target Engagement

The attack drones travel towards the target while remaining tethered to the drone-queen.
The operator maintains precise control, adjusting flight paths and target locks in real time.
Upon reaching the target, the attack drone deploys its munition with high precision.

### 3. Post-Engagement Sequence

After munition deployment, the fiber-optic connection is severed, ensuring no traceable signal remains.
The drone-queen retrieves any remaining drones and returns safely to the ground base for reloading and future missions.

1. A fiber-optic controlled unmanned aerial vehicle (UAV) system for operation in electronic warfare environments, comprising:
a carrier UAV having a body with an internal/external storage compartment or open platform;
a plurality of deployable attack drones removably housed within the internal/external storage compartment or open platform of the carrier UAV;
a fiber-optic tether system connected to the carrier UAV and comprising a plurality of optical fibers, each optical fiber being connectable to a respective one of the plurality of deployable attack drones;
a deployment mechanism mounted on the carrier UAV and configured to selectively release the plurality of deployable attack drones from the internal/external storage compartment or open platform, while maintaining connection through the fiber-optic tether system;
a control system in communication with the fiber-optic tether system and configured to transmit control signals through the optical fibers to the plurality of deployable attack drones; and
a disconnection mechanism configured to selectively sever the optical fibers connecting the carrier UAV to any of the plurality of deployable attack drones upon completion of a predetermined mission parameter.

2. The fiber-optic controlled UAV system of claim 1, wherein the fiber-optic tether system comprises a spool mechanism for each optical fiber, the spool mechanism configured to extend and retract the respective optical fiber during operation of the deployable attack drones.

3. The fiber-optic controlled UAV system of claim 1, wherein each of the plurality of deployable attack drones comprises:
a drone body;
a propulsion system coupled to the drone body;
a guidance system coupled to the drone body;
a payload compartment within the drone body; and
an optical interface configured to receive the control signals through the fiber-optic tether system.

4. The fiber-optic controlled UAV system of claim 3, wherein the payload compartment contains a guided munition.

5. The fiber-optic controlled UAV system of claim 1, wherein the control system comprises:
a signal processing unit configured to convert operational commands into optical signals;
a multiplexer configured to transmit the optical signals through multiple optical fibers simultaneously; and
a receiver configured to receive feedback signals from the plurality of deployable attack drones through the fiber-optic tether system.

6. The fiber-optic controlled UAV system of claim 1, wherein the disconnection mechanism comprises a cutting element configured to physically sever the optical fibers.

7. The fiber-optic controlled UAV system of claim 1, further comprising a retrieval mechanism configured to recover any of the plurality of deployable attack drones that remain connected to the carrier UAV through the fiber-optic tether system.
